(19) United States
(12) Patent Application Publication
(10) Pub. No.: US 2006/0179737 A1
(43) Pub. Date: Aug. 17, 2006

(54) Plastic panel hurricane protection system

(76) Inventor: Wayne Trundle, Calhoun, GA (US)

Correspondence Address: WAYNE TRUNDLE, 1268 MOULDIN ROAD, CALHOUN, GA, 30701, US

(21) Appl. No.: 11/352,842

(22) Filed: Feb. 13, 2006

Related U.S. Application Data
(60) Provisional application No. 60/652,548, filed on Feb. 14, 2005.

(51) Int. Cl. E06B 3/26

(52) U.S. Cl. 52/202

(57) ABSTRACT

A hurricane protection system, specifically for protection of the window and door openings in a building using transparent plastic panels attached in a manner that accommodates new and old architectural designs. The present system uses old standards and new unique methods, a transparent panel shaped to grow in strength when wind pressure is applied, attached to buildings using standard industry methods with an unique use of a rubber washer that acts as a shock absorber and lock washer on all bolted applications. The system has new and unique extrusions that allow the panels to be mounted away from the wall, to avoid protruding decorative trim and sills, in one-sixteenth inch increments.

### FIELD OF INVENTION

The present invention relates to plastic panel storm shutter and, more particularly, to a system of plastic panels with mounting methods to protect glass window and door openings in homes, office buildings and other walled structures from the destructive force of storm systems, such as hurricanes.

### BACKGROUND OF THE INVENTION

Violent storms are natural phenomena that often generate winds having the potential for destruction of property and life. This potential is evidenced upon review of the storm systems known as hurricanes that struck the United States in 2004 and 2005. Those hurricanes were especially destructive taxing the entire nation in the form of rebuilding costs and increased insurance rates. In light of the escalating costs for rebuilding, home owners, business owners and insurance companies alike have a common goal in protecting property. Proper shuttering of window and door openings, typically the weakest portion of a structure, has become a necessity if the structure's contents are to be protected.

The study of storms has determined that storm shutters must withstand more than just high winds. In reality the majority of the destruction is a direct result of impacts by debris carried by these high winds. In an effort to reduce the destructive effect of such windborne debris, changes to the building codes in areas frequently subjected to these type storms have been made, notably first in Florida, then throughout the coastal United States, with the introduction of the new Florida statewide code and next the International Building Code. One change made included in these codes requires that storm shutters withstand a large missile impact. Testing is performed by projecting a nine pound wood two by four at a velocity of 50 feet per second or higher, against the storm shutter being tested, this is intended to simulate the impact of windborne debris in a hurricane or similar storm. Then the shutter is wind resistance tested with 4500 cycles of wind up to one and one-half times the shutter design load to simulate the 3 second pulsating wind of a hurricane. To successfully pass, the shutter must remain intact after the testing.

Along with providing protection from such storms or hurricanes, it has been found desirable for storm shutters to be constructed of translucent materials so as not to nullify the main purpose of transparent glass window and door openings, especially when the electricity has been lost in a storm. The transparent materials prevent claustrophobic tendencies of occupants secured within the structure; yet permit law enforcement officials to inspect shuttered structures.

A number of U.S. patent numbers, notably U.S. Pat. Nos. 4,685,261, 4,175,357, 5,228,238 and 5,457,921, disclose various types of translucent storm shutter assemblies having a transparent panel constructed of flat plastic such as polycarbonate and mounted in a frame of aluminum or steel or a corrugated plastic such as polycarbonate and mounted in a frame of aluminum or steel. The plastic sheet used in the '261 and '357 patents is firmly secured to a frame with little if any allowance for expansion and contraction relative to the frame. Such restriction can cause the shutter assembly to become damaged even without exposure to storms. The plastic sheet used in the '238 patent, on the other hand, is mounted to its frame so as to allow each sheet relative freedom to expand and contact. As taught by the '238 patent, this problem may be avoided by mounting each plastic sheet in a frame so that it is relatively unrestricted and free to change in size in response to temperature changes. In order to accomplish this, however, the '238 patent discloses a very elaborate and thus relatively expensive storm shutter assembly. The '921 discloses a corrugated sheet of plastic such as polycarbonate, that was made of material 0.062 to 0.125 thick about 13 inches wide. The '921 patent shows a storm shutter that had to be put up in pieces and reinforced with aluminum or steel braces. This made the shutter very consumer unfriendly, unable to pass the new building codes and worse yet, no method of overcoming the loosing of the bolts used to hold the panel in place when the material contracted in size in response to temperature changes.

A common problem shared by transparent storm shutters of the prior art is that in order to successfully pass the current missile impact test, like previously described, each plastic sheet is relatively thick, typically on the order of a 0.5 inch or more, with a jigsaw puzzle of reinforcement. Since impact plastics such as polycarbonate are relatively expensive and heavy, these designs cannot compete in the market.

Therefore, there is a need for a transparent storm shutter that is relatively inexpensive to manufacture, is compatible with current shutter systems, is easy to install, overcomes the new architectural opening surround décor that protrudes from the wall and prevents the use of old mounting methods, yet capable of withstanding direct impacts from windborne debris during a storm.

### SUMMARY OF THE INVENTION

The present invention is directed to a relatively inexpensive corrugated transparent impact plastic such as thin lightweight polycarbonate, this shutter is made to replace multiple narrow panels with a panel large enough to cover an opening with one piece and eliminate the need for jigsaw puzzle reinforcement, making it consumer friendly. It is shaped with radius topped corrugations making it stronger with less weigh per square foot of coverage. When the radius corrugation top is wind loaded it flattens causing the perpendicular sides to go more perpendicular to the surface, thereby adding strength without adding weigh to the panel. The one piece panel eliminates panel joints, the weakest point in all prior art.

The present invention is a system of installations that are compatible with existing methods with changes that make it able to pass the needed code testing to become a viable product in today's hurricane protection market. The present invention lightweight polycarbonate panel cannot be bolted in place using the industry standard bolt and wingnut because the bolt thread will saw the hole open and the wingnut will spin off because when the plastic shrinks with temperature changes, the wingnut loosens and the hurricane force winds spin it off. The present invention system uses a rubber washer with all bolt and wingnut fastenings that acts as a shock absorber, prevents the screw from sawing the panel and is a lock washer to keep the wingnut from spinning off when the material shrinks due to changes in the temperature. This is accomplished by using a one-half inch diameter hole in the panel for a one-quarter inch diameter screw allowing room around the screw to squeeze the rubber washer between the screw and panel when the wingnut is applied. The shrinkage in the panel thickness is compensated with the rubber washer and it becomes a locking device for the wingnut thusly preventing it from spinning off.

The present invention is to a system of installations that eliminate the most common problems in installation of panel over décor surrounded openings. The present invention system using a “h” header that is an adjustable distance out from the wall of the structure in one-sixteenth inch increments. The “h” header is made of aluminum angle with segregations that meshes with an “u” shaped aluminum extrusion that has mating segregations, this allows the “u” part to be moved in and out, then screwed in place when the exact distance needed from the wall is obtained. The present invention system uses a matching “F” track sill that is an adjustable distance out from the wall of the structure in one-sixteenth inch increments. The “F” track sill is made of aluminum angle with segregations that meshes with a “F” shaped aluminum extrusion that has mating segregations, this allows the “F” part to be moved in and out, then screwed in place when the exact distance needed from the wall is obtained.

In one embodiment of the present plastic panel hurricane protection system it can be used with current standard mounting with the addition of the rubber washer. In other embodiments, the system can stand alone using the adjustable “h” headers and “F” tracks with rubber washers when bolted to the wall or mounting extrusions. This plastic panel hurricane protection system will give building occupants, when a storm is imminent and the shutters are mounted, light inside and the ability to see outside conditions. Still being secure by knowing the envelope of their building cannot be breached and flying debris will be deflected. Further, security after the storm, because the panels can be left up and not block the light at a time when electric is most likely to be out.

It has also been found that an additional benefit of the particular system is that it take an average of 12 panels with no reinforcement for the averages home, prior systems took 100 or more panels and elaborate reinforcement systems for the average home. The present plastic panel hurricane protection system takes about hour to install when a storm is imminent, prior systems take days instead of hours to install.

Another objective of the present invention is to teach a plastic panel may be secured in place and not restrict the thermal expansion and contraction of thin lightweight corrugated plastic panels with no chance of damage.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 is a perspective view of several embodiments of the present plastic panel hurricane protection system, it shows several ways a panel could be mounted and used to cover and protect a window or door opening in a structure.

FIG. 2 is a cross-section of plastic panel showing direct attachment and depicting the radii that gives the panel its strength.

FIG. 3 is a cross-section of fastener using a bolt or stud, a washer wingnut or sidewalk bolt and rubber washer, it depicts how the rubber washer is squeezed into the panel to act as a shock absorber on impact and a lockwasher when tightened.

FIG. 4 is a cross-section of an adjustable “h” header used in the present plastic panel hurricane protection system when a panel must mounted away from the wall to avoid décor around an opening.

FIG. 5 is a cross-section of an adjustable “F” track sill used in the present plastic panel hurricane protection system when a panel must mounted away from the wall to avoid décor around an opening, also the use of a rubber washer with bolt and wingnut.

### REFERENCE NUMBERS IN DRAWINGS

| | | | |
|---|---|---|---|
| 11 | Serrated large angle | 14 | Serrated “h” header |
| 17 | Serrated “F” track | 20 | Serrated small angle |
| 23 | Corrugated plastic panel | 26 | “h” header-industry standard |
| 29 | “F” track-industry standard | 32 | Extended “F” track-industry |
| | | | standard |
| 35 | Studded angle-industry standard | 38 | Tapcon screw |
| 41 | Bolt | 44 | Rubber washer |
| 47 | Washer wingnut | 50 | PanelMate Plus fastener |
| 53 | Stud | 56 | Tek screw |
| 59 | Sidewalk bolt | | |

### DETAILED DESCRIPTION OF THE INVENTION

Although the invention has been described in terms of a specific embodiment, it will be readily apparent to those skilled in this art that various modifications, rearrangements and substitutions can be made without departing from the spirit of the invention. The scope of the invention is defined by the appended hereto.

The present invention is directed to a system using a transparent panel 23 that is mounted over window and door openings in buildings protecting the window and door glass (not shown) from the high force winds and windborne debris typical of storm systems such as hurricanes.

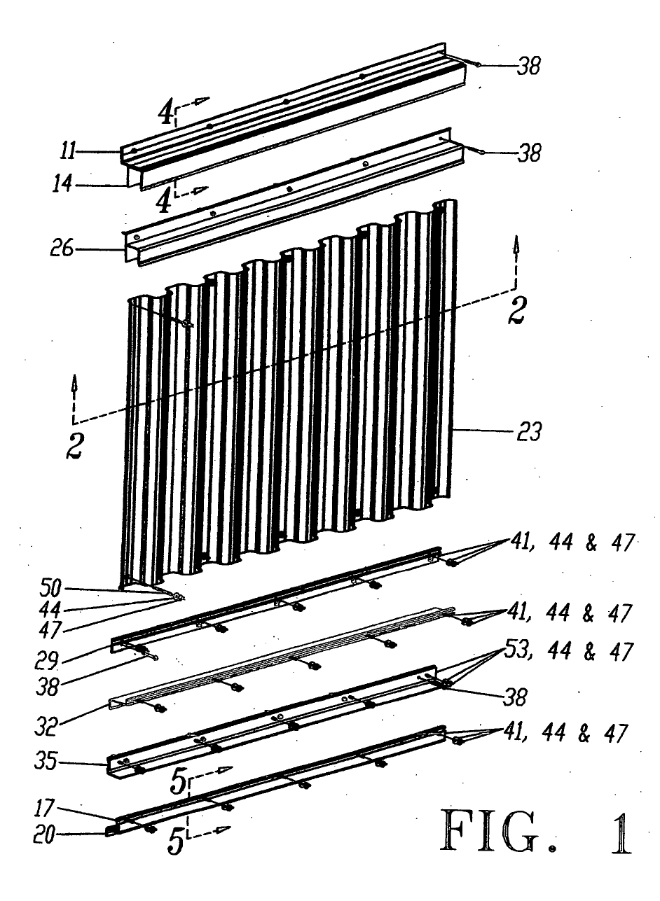

Referring in general to FIG. 1, one embodiment of the present plastic panel hurricane protection system allows mounting the panel several ways, using past industry standards, past industry standards with modifications and new methods that are part of this invention. At the top of the panel we can use the “h” header 26 an industry standard that is attached to the building with Tapcon screws 38 and the plastic panel 23 slides into the “h” header 26 or a “F” track 29 an industry standard that can be used at the head or sill (as shown) is attached to the building with Tapcon screws 38, the Plastic panel 23 is then bolted to the “F” track 29 using Bolt 41, Rubber washer 44 & Washer wingnut 47, the Rubber washer 44 being a key ingredient of this invention because it allows the use of thin lightweight Plastic panel 23 that expands and contracts with temperature changes, it also acts as a shock absorber in the one-half inch diameter hole in the Plastic panel 23 for a One-quarter inch diameter screw and a locking device for the Washer wingnut 47. This use of the Rubber washer 44 also applies in its uses further described herein. At the sill it shows the option to use the Extended “F” track 32, an industry standard which can also be used at the head (not shown), it builds the panel out from the wall a certain distance, the Extended “F” track 32 is mounted to the wall with Tapcon screws 38, the panel is then bolted to the Extended “F” track 32 using Bolt 41, Rubber washer 44 & Washer wingnut 47, the Rubber washer 44 being a key ingredient of this invention because it allows the use of thin lightweight Plastic panel 23 as stated above. At the sill it shows the option to use the Studded angle 35 an industry standard which can also be used at the head (not shown), Tapcon screws 38 are used to mount the Studded angle 35 to the building, the panel is then bolted to the Studded angle 35 using Stud 53, Rubber washer 44 & Washer wingnut 47, the Rubber washer 44 being a key ingredient of this invention because it allows the use of thin lightweight Plastic panel 23 as stated above. At the head and sill an optional direct mounting method is shown using a PanelMate plus 50 fastener, Rubber washer 44 and Washer wingnut 47, the Rubber washer 44 being a key ingredient of this invention because it allows the use of thin lightweight Plastic panel 23 as stated above.

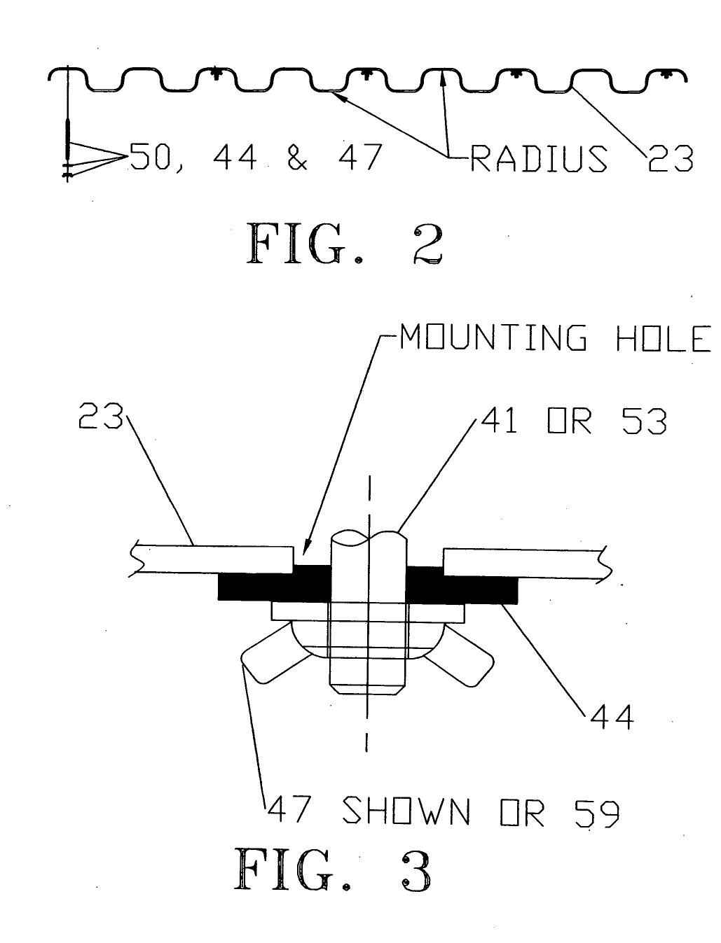

Referring to FIG. 2, one embodiment showing a cross-section of Plastic panel 23 that depicts direct attachment with PanelMate plus 50, Rubber washer and Washer wingnut 47. It show the unique radii on corrugation that gives it more strength per pound making the Plastic panel 23, such as polycarbonate, able to withstand the high winds associated with hurricanes.

Referring to FIG. 3, one embodiment showing an exploded view of the typical fastener using Bolt 41 or Stud 53, Washer wingnut 47 shown or Sidewalk bolt 59 and Rubber washer 44. It depicts the importance and uniqueness of the Rubber washer 44 being squeezed into the Plastic panel 23 between the Bolt 41 or Stud 53 such as one-quarter inch and the mounting hole in the Plastic panel 23 such as one-half inch by tightening the fastener so it may act as a shock absorber when the Plastic panel 23 is impacted. The Rubber washer 44 also acts as a lockwasher when tightened, this very important since Plastic panel 23, such as polycarbonate shrinks and expands with temperature changes, otherwise the fastener would loosen.

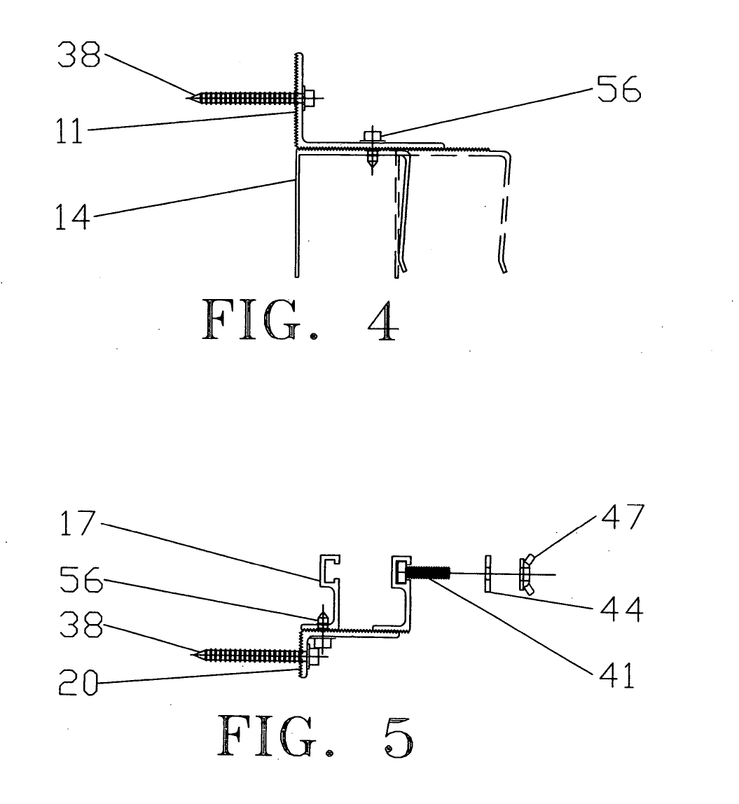

Referring to FIG. 1, one embodiment shown at the top is the use of Serrated large angle 11 and Serrated “h” header 14 used together to create an adjustable “h” header is a unique and innovative part of this plastic panel hurricane protection system patent and is better shown in FIG. 4, it is an adjustable “h” header that can be adjusted in one-sixteenth inch increments to build-out the panel from the wall a distance exactly as needed instead of a certain dimension, that may not fit, that current industry standard extended “h” header offer. The Serrated large angle 11 is mounted to the building with Tapcon screws 38, the Serrated “h” header 14 is meshed with the serrations in Serrated large angle 11 and set to the distance from the wall needed and locked in place with Tek screws 56, and the Plastic panel 23 slides into the “h” header 14.

Referring to FIG. 1, one embodiment shown at the bottom is the use of the Serrated small angle 20 and Serrated “F” track 17 used together to create an adjustable “F” track that is a unique and innovative part of this plastic panel hurricane protection system patent and is better shown in FIG. 5, a cross-section of an adjustable “F” track that can be adjusted in one-sixteenth inch increments to build-out the panel from the wall a distance exactly as needed instead of a certain dimension, that may not fit, that the current industry standard extended “F” track offer. The Serrated small angle 20 is mounted to the building with Tapcon screws 38, the Serrated “F” track 17 is meshed with the serrations in Serrated small angle 20 and set to the distance from the wall needed and locked in place with Tek screws 56, the panel is then bolted to the “F” track 29 using Bolt 41, Rubber washer 44 & Washer wingnut 47, the Rubber washer 44 being a key ingredient of this invention because it allows the use of thin lightweight Plastic panel 23 that expands and contracts with temperature changes.

Several exemplary Plastic panel 23, such as one-sixteenth to five-thirty second inches thick polycarbonate using this Plastic Panel Hurricane Protection System have successfully passed a large missile impact test performed according to the International Building Code (ICC), Florida Building Code (FBC) and ASTM International standards. The exemplary Plastic panel 23 teaches how to fasten lightweight to a structure that withstood the impact of a length of 2×4 lumber weighing nine pounds, traveling at a speed of 50 feet per second. Storm shutters using corrugated or flat sheet of polycarbonate with hard to install aluminum or steel reinforcements have not been able to pass this test unless the material thickness was too thick and heavy for practical applications.

Because the present Plastic Panel Hurricane Protection System uses existing standards with new and unique methods Plastic panel 23 can be mounted with less elaborate and less expensive mounting mechanisms makes it much more consumer friendly the methods previously used to mount panels. The Plastic panel 23 has the added benefit of enabling thinner and lighter sheets of the plastic material to be used while still providing the same of better degree of impact resistance afforded by much thicker flat or corrugated sheets of the same plastic material.

From the above disclosure of the general principles of the present invention and the preceding detailed description, those skilled in the art will readily comprehend the various modifications to which the present invention is susceptible. Therefore, only the following claims and equivalents should limit the scope of the invention thereof.

I claim:

1. A transparent system of shutter panels for protecting glass widow or door in a walled structure, comprising:
a corrugated sheet of shatter resistant and transparent plastic material with a mounting system of standard industry methods augmented by new innovative and unique methods using a rubber washer to act as a shock absorber for impact resistance and lockwasher that overcomes expansion and contraction of the plastic material due to temperature changes, also new unique mounting extrusions that allow to panel to be set off the in exact one-sixteenth inch increments to avoid protrusions, such decorative trim and sills; and
resist impact of flying debris in a storm and an impact of a two by four weighing nine pounds traveling at a speed of fifty feet per second without penetration.

2. The shatter resistant and transparent corrugated plastic of claim 1, each said corrugation have a thickness up to 1.934 inches of material up to about 0.125 inches.

3. The shatter resistant and transparent corrugated plastic of claim 1, each said corrugation have a thickness up to 1.934 inches of material up to about 0.093 inches.

4. The shatter resistant and transparent corrugated plastic of claim 1, each said corrugation have a thickness up to 1.934 inches of material up to about 0.063 inches.

5. The shatter resistant and transparent corrugated plastic of claim 1, each said corrugation having a width in the range from two to four inches.

6. The shatter resistant and transparent corrugated plastic of claim 1, each said panel having a width in the range from fifteen to seventy-four inches.

7. The shatter resistant and transparent corrugated plastic of claim 1, each said panel having a length in the range from three to sixteen feet.

8. A transparent plastic shutter panel for protecting glass window and door in a walled structure, comprising: a corrugated panel attached to the structure using a rubber washer that is squeezed into the panel between the fastening bolt or stud and the mounting hole, which is two times the bolt diameter, when the bolt is tightened and acts as a shock absorber and lockwasher, and
this unique use of a rubber washer adds flexibility and strength needed to withstand the impact of a nine pound wood two by four traveling at fifty feet per second without penetration, without the rubber washer the panel would fail the foregoing impact test.

9. The transparent plastic shutter panel of claim 8, without the rubber washer can not pass the impact test of a nine pound wood two by four traveling at fifty feet per second without penetration, failure to pass the foregoing impact test means this plastic panel hurricane protection system can not be used where the building codes require that test be passed making it an unmarketable product, that is the importance this unique use of rubber washers are to this claim.

10. The rubber washer of claim 8, each said rubber washer having a I.D. one times the bolt size.

11. The rubber washer of claim 8, each said rubber washer having a O.D. four times the bolt size.

12. The rubber washer of claim 8, each said rubber washer having a thickness in the range from 0.063 to 0.156 inches.

13. An adjustable mounting system that allows precision build-out distances from the structure to avoid protruding objects such as, decorative trim and sill, it is an adjustable “h” header made of aluminum angle serrated on the outside that is attached to the structure and a “u” shaped aluminum extrusion serrated on one side, the “u” serrations mesh with angle serrations to form an adjustable “h” header, then tek screwed in place, that can be adjusted in one-sixteen inch increments, to complete the system an adjustable “F” track made of aluminum angle serrated on the outside that is attached to the structure and a “F” shaped aluminum extrusion serrated on one side, the “F” serrations mesh with angle serrations to form an adjustable “F” track, then tek screwed in place, that can be adjusted in one-sixteen inch increments.

14. The aluminum angle serrated on the outside of claim 13, each said aluminum angle having a one leg in the range from one to three inches and one leg in the range from two to six inches.

15. The “u” shaped aluminum extrusion serrated on one side of claim 13, each said “u” shaped extrusion being of a size that the panel will slide into it in a range of two to three inches

16. The “F” shaped aluminum extrusion serrated on one side of claim 13, each said “F” shaped extrusion being of a size that the head of a bolt will slide into it.
